(19) United States
(12) Patent Application Publication
(10) Pub. No.: US 2026/0051068 A1
(43) Pub. Date: Feb. 19, 2026

(54) TRACKING AND TRAJECTORY PREDICTION FOR IN-PERSON LIVE ACTION GAMING

(71) Applicant: NIXO LLC, Pleasant Grove, UT (US)

(72) Inventors: Michael Wadman, Pleasant Grove, UT (US); Eric Thomas Alsop, Lexington, SC (US); Anup Ashok Mehta, San Ramon, CA (US); Sridhar Perepa, Mountain View, CA (US); Ravindra Adapa, Telangana (IN)

(73) Assignee: NIXO LLC, Pleasant Grove, UT (US)

(21) Appl. No.: 19/300,162

(22) Filed: Aug. 14, 2025

Related U.S. Application Data
(60) Provisional application No. 63/682,896, filed on Aug. 14, 2024.

(51) Int. Cl. G06T 7/246; F41J 5/14; G06T 7/73; G06V 20/40

(52) U.S. Cl. CPC G06T 7/246; F41J 5/14; G06T 7/73; G06V 20/40; G06T 2207/10016; G06T 2207/20081; G06T 2207/20084; G06T 2207/30196; G06T 2207/30204; G06T 2207/30241

(57) ABSTRACT

Systems and methods for tracking and trajectory prediction for in-person live action gaming are provided. In one example, video data is captured from multiple cameras monitoring a field of play in which multiple players are engaged in an in-person, live action game. The players and projectiles fired from respective projectile launchers of the players are tracked by applying one or more deep learning algorithms to the video data. Projectile trajectories and potential player impacts by one or more projectiles of the projectiles are predicted. A player of the multiple players is identified as an impacted player by confirming a hit on the player by a projectile fired from a projectile launcher of the respective projectile launchers associated with a shot originator without requiring use of a physical impact sensor on an outfit worn by the player. The hit is then attributed to the shot originator for scoring purposes.

### CROSS-REFERENCE TO RELATED APPLICATIONS

This application claims the benefit of priority of U.S. Provisional Application No. 63/682,896, filed on Aug. 14, 2024 which is hereby incorporated by reference in its entirety for all purposes.

### BACKGROUND

### Field

Various embodiments of the present disclosure generally relate to in-person live gaming involving multiple players. In particular, some embodiments relate to tracking and trajectory prediction of projectiles and/or players to facilitate shot hit detection (e.g., a player impact by a projectile) via one or more of image processing techniques, object tracking algorithms, estimation algorithms, and deep learning algorithms, potentially supplemented with additional information received from sensors (e.g., cameras and/or microphones) monitoring the field of play, wireless transmitters associated with the players, and/or sensors associated the projectile launchers (or guns).

### Description of the Related Art

Various types of in-person live action games may be played with multiple players involving the players shooting each other with projectiles (e.g., foam-based darts or balls, polymer beads (or water beads), soft thermoplastic rubber darts or balls, bean bags, and the like). Non-limiting examples of such games include:
Team vs. team
Everybody against everybody/free for all
Hide and seek
King of the hill
Sharp shooting or target practice
Any of these: https://skytechlasers.com/laser-tag-games-to-play-at-home/
Last man standing
Highest hit score, fewest misses, unlimited lives, limited lives

Gaming scenarios involving projectiles have been proposed in which players must wear a gaming outfit (e.g., uniform or suit) that can register impacts. Such gaming outfits may be disadvantageous for a number of reasons. For example, to provide comprehensive shot or impact detection for a player's body (e.g., torso, arms, legs, and/or head), the gaming outfits may become bulky, potentially restricting movement and/or inducing perspiration during game play. Alternatively, such gaming outfits may provide only a few limited areas (e.g., back, shoulders, and/or midsection) in which a shot or impact can be detected.

### SUMMARY

Systems and methods are described for tracking and trajectory prediction for in-person live action gaming. According to one embodiment, video data is captured from multiple cameras monitoring a field of play. Multiple players and projectiles fired from respective projectile launchers associated with a subset of the multiple players representing shot originators are tracked by applying one or more deep learning algorithms to the video data. Projectile trajectories and potential player impacts by one or more projectiles of the projectiles are predicted. A player of the multiple players is identified as an impacted player by confirming a hit on the player by a projectile of the projectiles fired from a projectile launcher of the respective projectile launchers associated with a given shot originator of the shot originators without requiring use of a physical impact sensor on an outfit worn by the player. The hit is then attributed to the given shot originator for scoring purposes.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram conceptually illustrating object tracking using image processing techniques.

FIG. 2 is a block diagram conceptually illustrating object tracking using a two-stage deep learning algorithm.

FIG. 3 is a block diagram conceptually illustrating object tracking using a one-stage deep learning algorithm.

FIG. 4 is a block diagram conceptually illustrating object tracking using deep learning algorithms in accordance with various embodiments of the present disclosure.

FIG. 5 is a block diagram conceptually illustrating an operational environment in which tracking and trajectory prediction may be employed in accordance with various embodiments of the present disclosure.

FIG. 6 is a block diagram providing a conceptual overview of performing object tracking in accordance with various embodiments of the present disclosure.

FIG. 7 is a flow diagram illustrating field of play monitoring in accordance with an embodiment of the present disclosure.

FIG. 8 is a flow diagram illustrating video frame processing in accordance with an embodiment of the present disclosure.

FIG. 9 is a flow diagram illustrating operations for performing hit detection in accordance with various embodiments of the present disclosure.

FIG. 10 illustrates an example computer system in which or with which embodiments of the present disclosure may be utilized.

### DETAILED DESCRIPTION

Systems and methods are described for tracking and trajectory prediction for in-person live action gaming. To address or at least mitigate various limitations of existing gaming outfits, a shot hit detection approach is proposed herein that need not rely on detection of physical impact by the gaming outfits. As described further below, instead shot hit detection may be implemented based on one or more of image processing techniques, object tracking algorithms, estimation algorithms, and deep learning algorithms, potentially supplemented with additional information, for example, sound detection, object location/mapping using wireless communication signals, player tracking (e.g., via WiFi positioning), projectile launch signals provided by the projectile launchers (or guns), and the like.

In some examples, the game may be played in an enclosed indoor arena with possible obstacles and other elevations and each player has a gun and a uniform. In some cases the player uniforms may include different colors, patterns, and/or markings (e.g., numbers, names, barcodes, or Quick Response (QR) codes) to allow each player to be uniquely identified within the field of play. Additionally, or alternatively, players may be identified by virtue of other visual markers (e.g., relative size, uniform color, uniform pattern, or other markings) or non-visual markers (e.g., thermal or infrared (IR) signatures). Similarly, the projectiles (e.g., launched by the guns) may be capable of association with a particular player or gun by virtue of their respective size, color, shape, surface pattern, or other markings.

In some cases, the gun may be fully automatic (i.e., firing a continuous stream of projectiles until a trigger is released), bursty (i.e., firing a finite number greater than one of projectiles upon each distinct pull of the trigger), semi-automatic (i.e., firing a single projectile on each distinct pull of the trigger), or manual (i.e., requiring a manual loading of the gun followed by a trigger pull for each projectile fired). The projectiles may be made of foam or other substance that will soften impact, and yet dense enough to move through an atmosphere at a sufficient rate to accommodate the size of the playing field or arena. A combination of a density of the projectile along with a velocity at which the projectile leaves the muzzle of the gun may be programmable such that the combination of velocity and density allow the projectile to impinge another player without penetrating, but offering a varying impact intensity. For example, a force at which the projectile impacts another player in the arena at a defined distance from the gun shooting the projectile can be programmed range from allowing the impacted individual to feel a painful hit (like paintball) all the way to an impact that may be difficult to be sensed by the individual. Such programming may be done via a central server (e.g., on-premises or in the cloud), and may be modified in real time as a game is being played. In some cases, the gun may be equipped with a range finder and may be configured not to fire a projectile unless the target range is greater than a programmable distance away. This allows for increasing the force at which projectiles impact other players while keeping game operation within defined safety limits.

In some embodiments, high-speed cameras may be used to capture visual data (which may also be referred to herein as video frames and/or video data) associated with projectiles released from projectile launchers (or guns). For example, a high-speed camera may be mounted to each projectile launcher to facilitate determination of the time at which the projectile was fired and/or the trajectory of the projectile. In some examples, each projectile launcher may include an accelerometer (or an inertial measurement unit (IMU)) to allow one or more of an angle of inclination and height of the barrel of the projectile launcher to be determined at the time of the release of a projectile from the projectile launcher. Alternatively or additionally, a number of high-speed cameras may monitor the field of play from various points of view (e.g., mounted to walls enclosing an arena and/or mounted to the ceiling). The sensors (e.g., cameras, microphones, accelerometers, and the like) and/or location determining devices (e.g., wireless communication systems employing one or more of WiFi, Bluetooth™, cellular, radio, or other current or future wireless communication technologies) utilized by various embodiments may be coupled in communication with a central server (e.g., located on premises or in the cloud) that implements one or more tracking and trajectory prediction techniques for either or both of projectiles and players to make shot hit detection determinations for game scoring and/or other game metrics. For example, as described further below, based on the ability to track and predict the trajectory of a given projectile, uniquely identify a given player, locate and/or track players within the field of play, and map the given projectile to the shot originator, for instance, based on known correspondence between the given projectile and the projectile launcher utilized by the shot originator, the central server is able to accurately perform, among other things, predictions regarding whether and when the given projectile will impact another player, shot attribution, and identification of the shot originators.

While in the context of some examples described herein one or more Artificial Intelligence (AI) solutions may be used to perform tracking and trajectory prediction of multiple fast moving objects (e.g., projectiles fired at each other by players of a live action in-person game) that have differentiating attributes that allow disambiguation among them, it is to be appreciated such AI solutions may be replaced by or supplemented with other trajectory prediction approaches. Additionally, while various examples are described with reference to multi-player games in which players fire, launch, or throw projectiles at one another, it is to be appreciated the tracking and trajectory prediction methodologies described herein are equally applicable to game modes in which players direct projectiles at targets (moving or stationary and with markings for tracking), virtual players, and/or virtual projections one walls/screens. For instance, in alternative embodiments, one or more players may go through an arena shooting at targets and/or virtual players and may be awarded or gain points based on accuracy, speed, and/or number of targets hit.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in herein, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

The terms “component”, “module”, “system,” and the like as used herein are intended to refer to a computer-related entity, including one or more of a software-executing general-purpose processor, hardware, firmware, and/or various combinations thereof. For example, a component may be, but is not limited to being, a process running on a hardware processor, a hardware processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider or hyperscaler (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein, a “projectile launcher” generally refers to any manual or automated means of firing, launching, throwing, or otherwise projecting a projectile. For example, depending on the particular implementation, a projectile launcher may include a mechanical device firing or launching a projectile or a player's hand or body part throwing a projectile.

As used herein, a “projectile” generally refers to any body projected by external force and continuing in motion by its own inertia. Non-limiting examples of projectiles include ball-shaped rounds or bullets made of foam (e.g., Nerf® Accu-Rounds), darts or long, foam projectiles with or without a rubber tip (e.g., Nerf® N Series N1 Darts), bean bags, polymer beads (or water beads), soft thermoplastic rubber darts or balls, and the like. Depending on the particular implementation, projectiles that are intended for throwing may be ball-shaped or in the shape of any type of weapon (e.g., knife, axe, dart, javelin, ninja star, boomerang, plumbata, bola, throwing club, and/or the like). In various examples, projectiles may have one or more differentiating visual attributes (e.g., size, color, shape, surface pattern, or other markings) to facilitate object detection, recognition, and/or tracking. In some examples, fast-moving projectiles may be traveling at approximately between 10 to 50 meters per second (m/s).

As used herein, an “occlusion” generally refers to a phenomenon in which an object (e.g., a projectile or a player) in a scene is partially or completely hidden from view by another object (e.g., another player, an obstacle, etc.). As described further below, in various embodiments described herein, object tracking and estimation is expected to handle brief or temporary occlusions (e.g., of on the order of about 1 to 5 video frames at about 50 to 120 FPS while maintaining unique and persistent object identity (e.g., in the form of internally used tracking IDs) for all tracked objects, including scenarios in which one or both of (i) a particular tracked object is temporarily occluded or goes out of sight and reappears during a time at which the field of play is experiencing changing environment conditions (e.g., changes in lighting conditions, changes in background conditions, and/or the like) and (ii) the particular tracked object transitions through multiple camera fields of view during a time at which the field of play is experiencing changing environment conditions.

As used herein, “telemetry data” generally refers to data gathered from various sources (e.g., sensors or wireless communication devices (e.g., mobile phones) associated with players or sensors associated with projectile launchers) and provided to a central server. For players, the telemetry data may include location data and a player identifier. For a particular projectile launcher, the telemetry data may include information indicative of one or more of a location of the particular projectile launcher, a release angle of the projectile, an initial release velocity of the projectile, a time at which the projectile was fired from the particular projectile launcher, and a unique identifier associated with the particular projectile launcher.

As used herein, a “shot originator” generally refers to a player whose projectile launcher (or gun) launched (or fired) a projectile at issue.

As used herein, an “impacted player” generally refers to a player that has been confirmed to have been hit by a projectile

As used herein, “shot hit detection” or “hit detection” generally refers to detecting whether a player has been impacted by a projectile. In various examples described herein, information regarding projectile trajectories, player locations, and player paths may be predicted or calculated, for example, based on object detection performed on video frames received from a number of cameras monitoring the field of play. Player locations and corresponding unique player identifiers may be tracked in real-time within a real-time arena player location map based on player location information determined with reference to location information derived from video frames by object detection algorithms and triangulation, location information received from of a projectile launcher associated with a given player, location information derived from WiFi signals associated with the given player's mobile phone, and/or the like. As described further below, the real-time arena player location map may be used in combination with calculations, projections, and/or predictions relating to projectile trajectories to facilitate shot hit detection. Additional information (e.g., a unique identifier associated with the projector launcher from which the projectile was fired and information regarding a player to which the projectile launcher is assigned) may be used to facilitate shot attribution.

As used herein, “shot attribution” generally refers to crediting or associating a particular impact by a particular projectile on an impacted player to or with the shot originator. In some game play scenarios, the source of a projectile that has been determined to have impacted a player may be of consequence. For example, for purposes of game scoring and/or tracking individual player metrics, a projectile launched by a projectile launcher (or gun) of (associated with) a given player that has been determined to have impacted another player, may result in one or more points being credited to a team with which the shot originator is associated and/or to the shot originator.

As used herein, “keypoints” generally refer to distinctive points in an image or video frame that can be reliably detected. Keypoints may be used for various tasks including object recognition, image alignment, and pose estimation. Keypoints are often characterized by high contrast, sharp edges, or corners and are chosen for their uniqueness and invariance to transformations like rotation, scaling, and lighting changes.

Various proposed approaches for robust tracking and trajectory prediction of multiple fast moving objects (e.g., projectiles) in controlled environments where the objects may be occluded from the camera field of view for brief periods of time or expected to be re-identified in a completely new session or while moving from one camera field of view to another camera field of view will now be described.

In a typical computer vision based object tracking system, each object is internally associated with a unique identifier and maintains this identity across frames captured from a camera or from a number of different cameras. This may be achieved through a number of different methods including (i) applying image processing techniques as described below and (ii) using artificial intelligence (AI) solutions (e.g., deep learning based object detection and a mix of object tracking algorithms).

### Example Method 1—Application of Image Processing Techniques

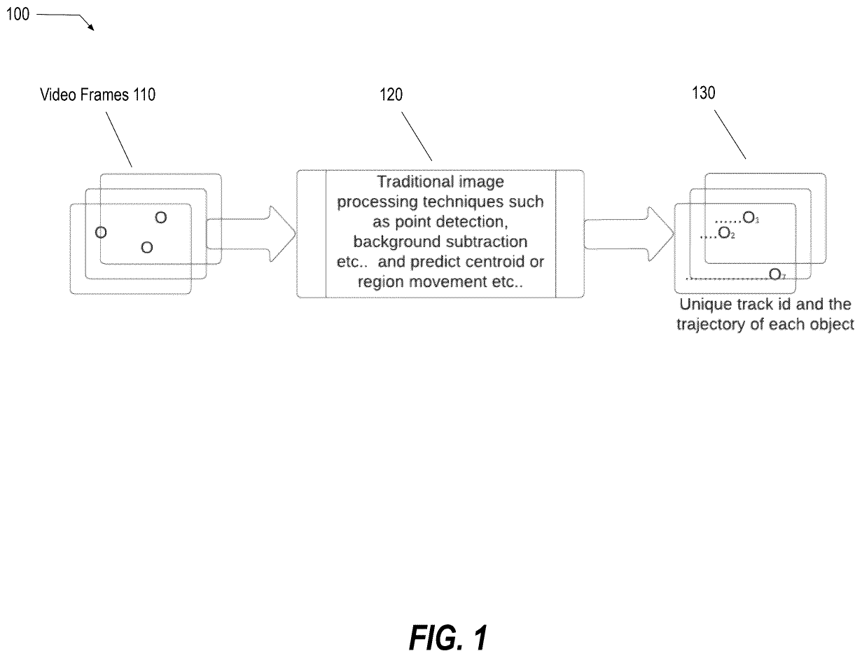

FIG. 1 is a block diagram conceptually illustrating object tracking 100 using image processing techniques, which may be referred to as “Method 1” herein. In this example, input video frames (e.g., video frames 110) containing images of a number of objects are processed by one or more traditional image processing techniques 120. Such traditional image processing techniques 120 may include point detection, background subtraction and the like, which are generally operable to predict centroid or region movement. The traditional image processing techniques 120 may be used to determine a trajectory of each object detected within the input video frames and a unique tracking identifier may be assigned to each object as part of a tracked output 130.

Non-limiting examples of potential issues/limitations associated with Method 1 include assignment of duplicate internal tracking identifiers to the same object (e.g., a given projectile fired from a projectile launcher). For example, if an object disappears from the frame and reappears later, reference to the centroid may be lost and the reappeared object may be identified as a completely new or different object and a new internal identity would then be associated with it. In FIG. 1, while the input video frames show 3 objects, in the tracked output 130, these 3 objects are given identities of a 1^{st}, 2^{nd} and 7^{th} object as if there are 7 objects in the input video frames (assuming the identities are associated with a sequential number starting from 1).

### Example Method 2—Use of AI Solutions

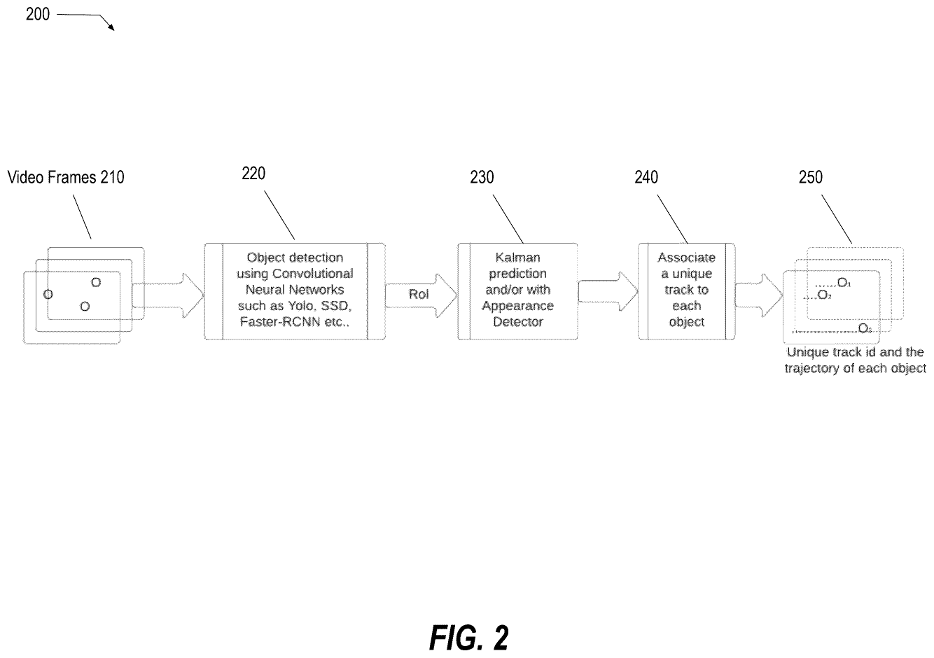

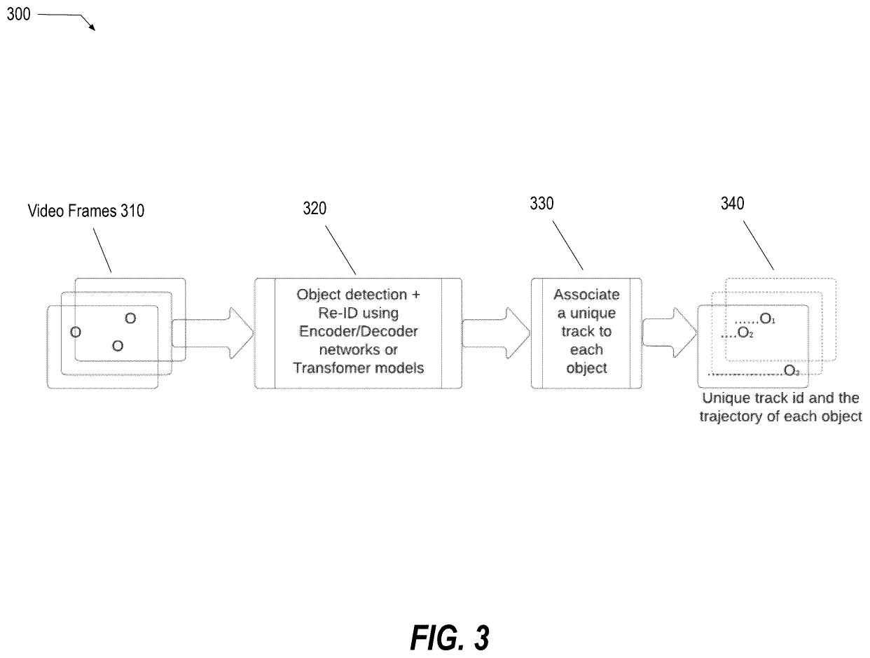

FIG. 2 is a block diagram conceptually illustrating object tracking 200 using a two-stage deep learning algorithm, which represents one example approach that may be referred to herein as “Method 2”. This example seeks to address or at least mitigate the issues/limitations of Method 1. For example, approach of Method 2 solves the issue with respect to the potential for re-identification of the same object as a new or different object when it disappears for a few frames and reappears. In the context of the present example, Method 2 is shown as being carried out either in one stage (FIG. 2) or two stages (FIG. 3).

When performed in two stages as illustrated below with reference to FIG. 2, the first stage (e.g., an object detection stage 220) may involve performing object detection based on input video frames (e.g., video frames 210), which may be followed by a second stage (e.g., an object tracking stage 230) that makes use of one or more tracking algorithms (e.g., Kalman filter, Hungarian algorithm, simple, online, and realtime (SORT) tracking, and/or an appearance detector) to associate objects detected in consecutive frames of captured video and assign a unique tracking identifier (ID) to each object (in block 240). These tracking algorithms consider various factors, for example, object position, size, and appearance to reliably track objects over time. As such, as illustrated in the tracking output 250, the three tracked objects appearing in the input video frames are correctly assigned a 1^{st}, 2^{nd}, and 3^{rd} unique track ID and none of the objects have been identified as a new or different object as a result of temporary occlusion and subsequent reappearance.

Alternatively, when performed as a single stage, for example, as depicted in FIG. 3, object tracks may be formed while simultaneously detecting and tracking objects (e.g., within an object detection stage 320) by learning appearance embeddings (e.g., color, texture, and/or shape of the object) across frames the input video frames (e.g., video frames 310). To maintain object tracks or timestamps of object detections, the appearance embeddings may be incorporated into a transformer model while capturing motion information to anticipate the object's position even when it is occluded. At block 330 (which may be analogous to block 240) a unique tracking ID may be assigned to each object. Finally, in the tracking output 340 (which may be analogous to the tracking output 250), the three tracked objects appearing in the input video frames are again correctly assigned a 1^{st}, 2^{nd}, and 3^{rd} unique track ID without identification of any of the objects as a new or different object as a result of temporary occlusion and subsequent reappearance.

Improvements to Method 1: Method 2 generally improves re-identification of an object in scenarios in which the object disappears and reappears into the field of view after a brief period of time due to occlusions, etc. For example, such improvement is achieved through Method 2's usage of additional data, such as objects appearance (e.g., size, shape, and/or color) while associating a unique identifier with a given object. As shown in FIGS. 2 and 3, the input video frames show 3 objects; and in the tracked output these 3 objects are given identities of 1^{st}, 2^{nd}, and 3^{rd} objects (again, assuming the identities are associated with a sequential number starting from 1).

Potential issues/limitations associated with Method 2: In situations in which (i) the external environment changes at the time at which an object goes out of sight and then later re-appears, for example, changes in lighting condition while an object is transitioning from the field of view of one camera to another camera's field of view or before and after passing through an occlusion, etc.; or (ii) the appearance detector fails to extract the additional data correctly to associate the identity correctly, a new unique identifier would be internally associated with the same object (which was previously assigned an earlier unique ID as in the case of Method 1).

To address these potential scenarios in which objects may be misidentified as new or different objects as a result of potential external environment changes and/or a failure on the part of the appearance detector to otherwise be able to extract the additional data to correctly associate an identity with a given unique object, the appearance detector may require retraining for all new situations, environment that might create such misidentification issues. In many use cases, such retraining may not be feasible.

### Example of the Proposed Object Tracking and Trajectory Prediction Approach

This disclosure proposes a new method to maintain unique and persistent object identity in both scenarios, including (i) an object becoming temporarily occluded or going out of sight and reappearing and (ii) an object transitioning through multiple camera fields of view with changing environment conditions.

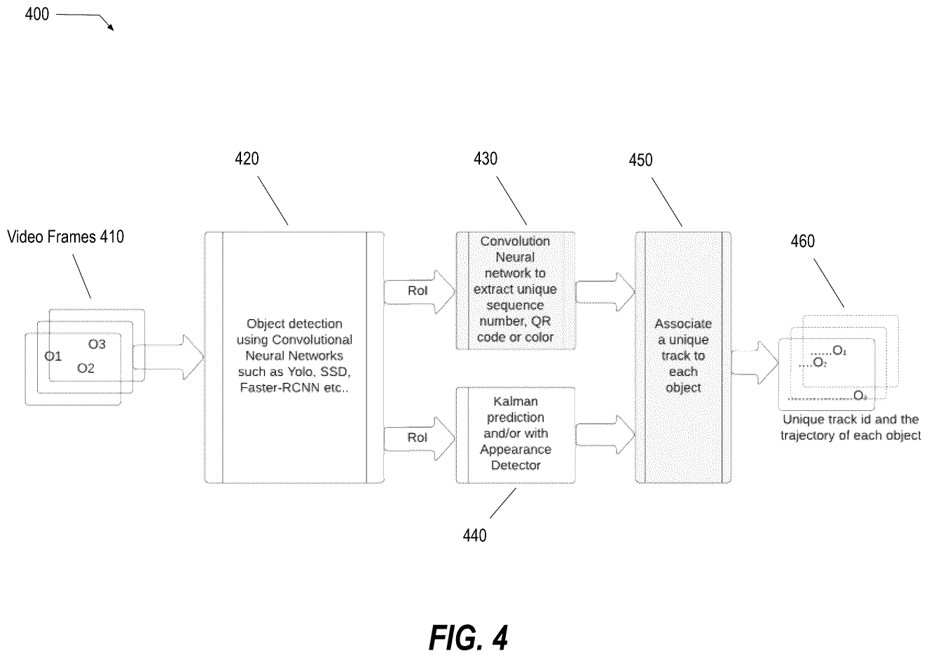

FIG. 4 is a block diagram conceptually illustrating an AI pipeline 400 for object tracking using deep learning algorithms in accordance with various embodiments of the present disclosure. In a controlled environment, one would know the number as well as conditions under which objects (e.g., players and/or projectiles released by projectile launchers) are to be tracked. As shown in FIG. 4, according to one embodiment, it is proposed to have various subsets of projectiles used for the in-person live action gaming include differentiating attributes (e.g., one or more of size, shape, texture, color, surface pattern, or other markings). For example, each projectile launcher may be pre-loaded with (or the player to which a particular projectile launcher is assigned by may supplied with) projectiles that are capable of being disambiguated from the projectiles used for other projectile launchers to allow a given projectile to be mapped back to the particular projectile launcher from which it was fired and therefore also further facilitate mapping to a given player (e.g., the shot originator) known to be utilizing the particular projectile launcher during the game at issue. Additionally, in one embodiment, player uniforms (or gaming outfits) may have a unique identifier be pre-marked or labeled thereon (e.g., a unique sequence of numbers and/or letters, a color, and/or other markings (e.g., a barcode or a QR code which would contain a unique identifier corresponding to that player)).

In the context of the present example, a Convolutional Neural Network (CNN) processing block (e.g., block 430) is added on top of Method 2 described above, to process the differentiating attributes of the projectiles and the pre-marked unique identifiers of player uniforms detected in the Region of Interest (Rol). As such, in this example, the proposed approach involves processing input video frames (e.g., video frames 410 received from the multiple cameras monitoring the field of play) by an AI-based object detection stage 420, which may involve the use of one or more CNNs (e.g., You Only Look Once (YOLO), EfficientDet, Detectron2, Single Shot MultiBox Detector (SSD), Faster-Region-CNN (Faster-R-CNN), or the like). The output from this additional CNN processing block 430 may then be used while associating a unique identifier to the object being tracked (e.g., in block 450), which may be analogous blocks 240 and 330, albeit, with improved performance for various occlusion and field of view transition scenarios). In this example, an object tracking stage (e.g., object tracking stage 440 may be analogous to object tracking stage 230) and a tracking output 460 (which may be analogous to tracking output 240 and 340) may produce results including a unique internally used tracking ID and trajectory or path of each tracked object. With the inclusion of the additional CNN processing block 430 that processes the differentiating attributes of the projectiles and the pre-marked unique identifiers of the player uniforms, unique and persistent object identity (e.g., in the form of internally used tracking IDs) may be maintained for all tracked objects in scenarios involving one or both of (i) a particular tracked object becoming temporarily occluded or going out of sight and reappearing during a time at which the field of play is experiencing changing environment conditions (e.g., changes in lighting conditions, changes in background conditions, and/or the like) and (ii) the particular tracked object transitioning through multiple camera fields of view during a time at which the field of play is experiencing changing environment conditions.

### Example Operational Environment

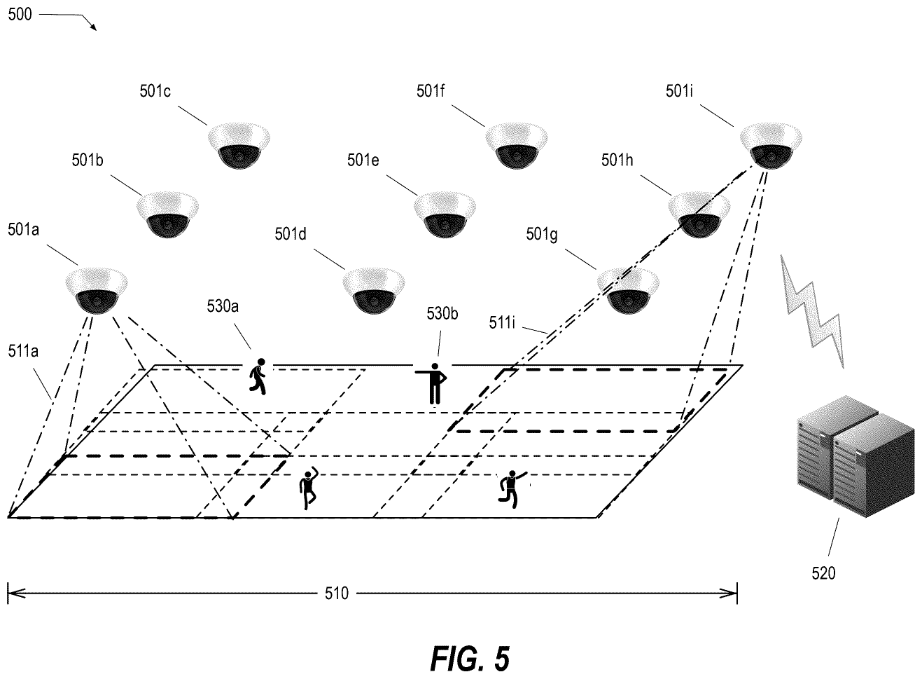

FIG. 5 is a block diagram conceptually illustrating an operational environment 500 in which tracking and trajectory prediction may be employed in accordance with various embodiments of the present disclosure. In the context of the present example, a field of play 510 in which multiple players (e.g., players 530a-b) may be engaged in an in-person live action game (e.g., team vs. team, everybody against everybody/free for all, hide and seek, king of the hill, sharp shooting or target practice, last man standing, highest hit score, fewest misses, unlimited lives, limited lives, etc.), may be monitored by multiple cameras (e.g., cameras 501a-i). The cameras may have overlapping fields of view (e.g., fields of view 511a and 511i). In one example, global shutter cameras (e.g., FLIR Blackfly, Basler ace) may be used at 90-240 frames per second (FPS). The cameras may be thermal or infrared IR-capable for low light and/or may have wide-angle or telephoto lenses. Depending on the particular implementation and/or gaming location the cameras may be mounted overhead and/or placed on opposing walls with overlapping fields of view, thereby providing homography for performance of three-dimensional (3D) stitching.

Additionally, as described further below, sound waves may be processed, for example, sound waves picked up a microphone array (not shown) to facilitate detection or confirmation regarding a firing of a projectile from a projectile launcher. Based upon the disclosure provided herein, one of ordinary skill in the art will recognize a variety of sensors (e.g., triangulation sensors) and sensor locations that may be used to gather information about players within the field of play.

As noted above, in some examples, the game may be played in an enclosed indoor arena with possible obstacles and other elevations and each player has a projectile launcher (e.g., projectile launcher 601) and a uniform. In some cases, the player uniforms may include different colors, patterns, and/or markings (e.g., numbers, names, barcodes, or QR codes) to allow each player to be uniquely identified within the field of play. Similarly, the projectiles fired by the projectile launchers may be capable of association with a particular player or projectile launcher by virtue of their respective differentiating attributes (e.g., one or more of size, shape, texture, color, surface pattern, or other markings). Such other markings may, but need not, include the projectiles being labeled or otherwise marked with unique identifiers (e.g., a bar code or a QR code).

As described further below, during game play, video frames captured by the cameras may be transmitted to a central server (e.g., central server 520 or a set of multiple servers operating together as a centralized data processing platform for a single gaming location or for multiple gaming locations). The centralized data processing platform may be responsible for, among other things, performing shot hit detection, performing shot attribution, processing player scores, and properly displaying credit and scores for each player. The centralized data processing platform may rely on WiFi, Bluetooth™ or other wireless or wired technologies to send and/or receive data and may be located on-premises or may be hosted in a public cloud or private cloud. Non-limiting examples of additional data that may be provided to the centralized data processing platform include (i) telemetry data from the projectile launchers, for example, including one or more of a confirmation that a projectile has been fired by the particular projectile launcher (e.g., a shot filed indicator or a projectile launch indicator), a location of the particular projectile launcher supplying the telemetry data, orientation (e.g., indicative of a release angle of the projectile and a height of the barrel) of the projectile launcher at the time of the firing of the projectile, an initial release velocity of the projectile, a time at which the projectile was fired from the particular projectile launcher, and a unique identifier associated with the particular projectile launcher. Some subset of the telemetry data may be supplied by one or more sensors (e.g., an accelerometer or IMU) associated with the projectile launcher

### Overview of Object Tracking and Hit Detection

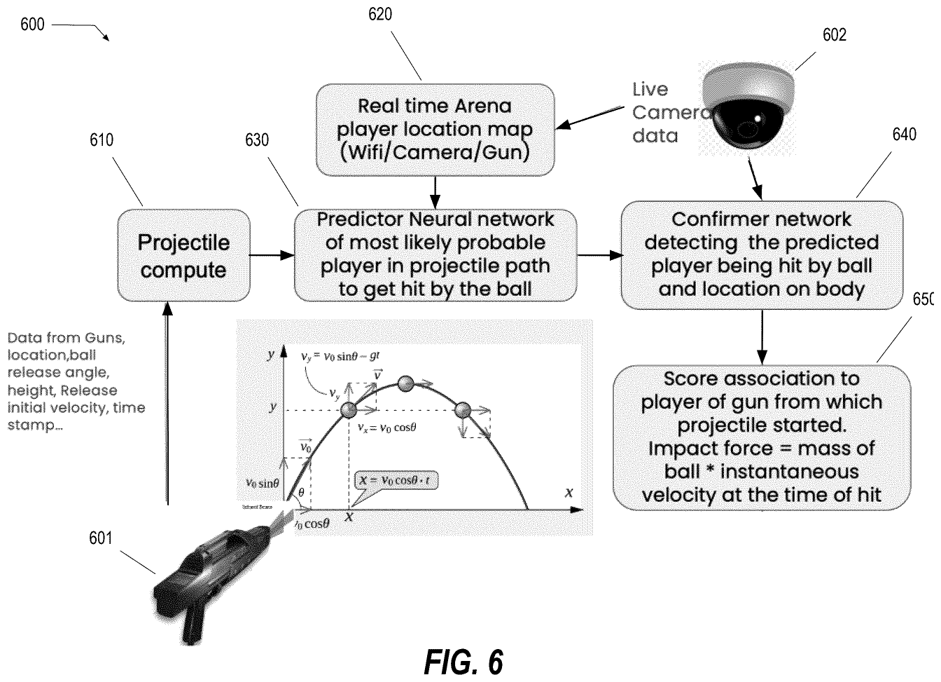

Based on the proposed improvements to Method 2, an approach is described herein for detecting a moving target (e.g., a player) that has been or will be hit from the possible list of targets following the trajectory of a fast moving object (e.g., a projectile) in a constrained environment. A conceptual overview of an example of the proposed approach is described with reference to FIG. 6. FIG. 6 is a block diagram providing a conceptual overview 600 of performing object tracking in accordance with various embodiments of the present disclosure.

In the block diagram of FIG. 6, a method is proposed for accurately detecting a player/object/target that is hit by another fast moving object (e.g., a projectile) in a controlled environment (e.g., a projectile released from a gun in a shooting game arena). In this example, the object identities and their trajectory paths (e.g., determined based on image processing techniques and/or with one or more deep learning algorithms) are provided as an input to a predictor algorithm that outputs the first intersecting or the least deviation in the path of the source (e.g., the shot originator) and the target (another player involved in the in-person live action game).

In the context of the present example, multiple neural networks may be used, including a predictor neural network 630 (e.g., a Multilayer Perception (MLP) neural network) and a confirmer network 640 (e.g., making use of CNN-based classification). A projectile compute module 610 may perform projectile computations relating to projectile trajectories, for example, based on projectile data (e.g., projectile release angle, height, release initial velocity, and time of release) provided by one or more sensors associated with projectile launchers (e.g., projectile launcher 601). A central server (e.g., central server 520) may also maintain a real-time arena player location map 620 based on one or more of wireless (e.g., WiFi or Bluetooth) positioning and/or image processing techniques. The wireless positioning may make use of wireless signal information associated with a wireless communication device (e.g., a mobile phone) carried by a player and/or a wireless communication device coupling a given projectile launcher with the central server.

Depending on the particular implementation, projectile launchers may include one or more integrated or attached sensors, for example, an accelerometer or an IMU and/or a projectile fired detection mechanism (e.g., an infrared (IR) break-beam, a Jetson Nano+Raspberry Pi camera, and/or the like). As those skilled in the art will appreciate, an integrated or attached sensor to indicate when a projectile has been fired from a projectile launcher provides sensor-redundant firing detection.

According to one embodiment, the output of the projectile compute module 610 and real-time arena location map 620 are input to the predictor neural network 630. According to one embodiment, the projectile compute module 610 estimates a trajectory for each projectile fired by a projectile launcher (e.g., projectile launcher 601) in the field of play. Depending on the particular embodiment, a projectile launch indicator or shot fired indicator may be provided by a given player's projectile launcher when a projectile is fired by the given player's projectile launcher and/or a microphone array may be used to detect sounds in the field of play. When a microphone array is employed, the projectile launch indicator or shot fired indicator may be the result of application of AI techniques, for example, a trained sound classification neural network making an inference based on sound waves it has received directly or indirectly from the microphone array that a sound contained in the received sound waves is indicative of a projectile having been fired from a projectile launcher in the field of play.

Based on the output of the output of the projectile computation 610 and the player locations provided by the real-time arena location map 620, the predictor neural network 630 may make an inference regarding the most likely player in the path of a given projectile that will be hit by the projectile. The confirmer network 640 may then determine whether the player predicted by the predictor neural network 630 has actually been hit by the given projectile. In some examples, the confirmer network 640 may also determine a location on the body of the player impacted by the given projectile. Additionally, scoring may be performed by a scoring module 650 based on the confirmation that a player has been hit (and potentially based on the location on the body of the impact) by a projectile of a shot originator. In some embodiments, Reinforcement Learning (RL) may be used for adaptive hit confirmation. For example, one or more RL agents may be used in the confirmer network 640 to learn optimal hit thresholds over time, based on feedback from past games (e.g., rewarding accurate detections and penalizing false positives). In this manner, self-improvement is facilitated by a system implementing the proposed approach as the system may be dynamically calibrated based on such feedback.

The various AI models described herein may be trained with synthetic data generated from simulation environments and may then be fine-tuned with real footage of the field of play. In one example, synthetic data may be generated via Unity/Unreal and edge AI solutions (for edge deployments) may be facilitated by employing NVIDIA Jetson. In one example, physics equations (e.g., drag and gravity) may be directly integrated into the neural network architecture (e.g., the predictor neural network 630), thereby allowing hybrid learning from both data and physical laws. For example, the neural network architecture may be trained on simulated arena data to predict projectile paths with reduced error in windy and/or obstructed conditions.

In some examples models may be trained collaboratively across multiple gaming locations with or without sharing raw data. In the case of the latter, aggregated gradients may be shared for privacy preservation. In this manner scalability may be enhanced for franchised arenas and data privacy concerns may be proactively address in multi-site deployments.

It is further contemplated that AI-driven dynamic game balancing may be performed. In some embodiments, projectile parameters (e.g., speed, density, etc.) may be adjusted in real-time based on player performance metrics using machine-learning techniques, for example, to enhance the fairness of matches.

### Example Field of Play Monitoring

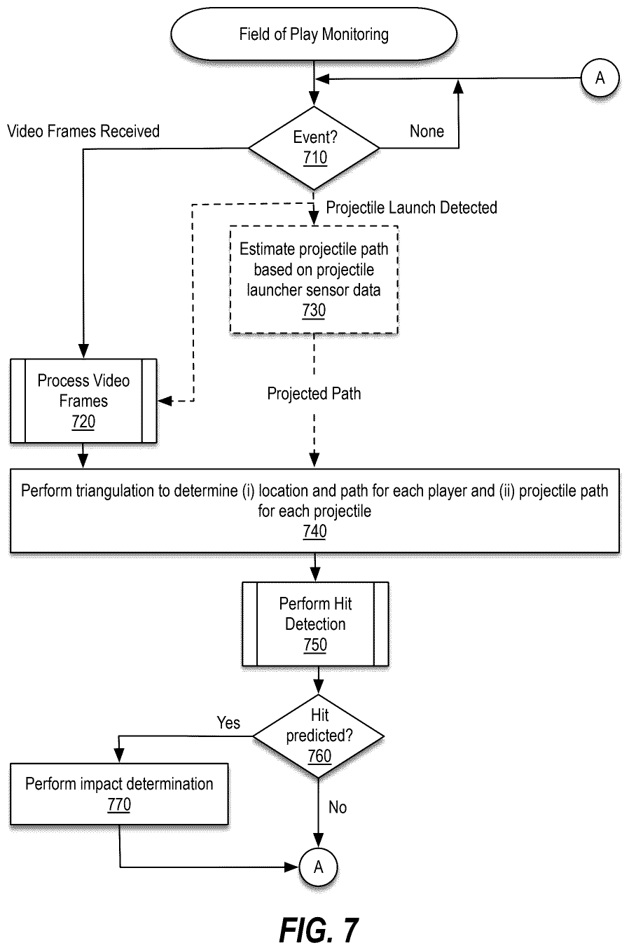

FIG. 7 is a flow diagram illustrating field of play monitoring in accordance with an embodiment of the present disclosure. The monitoring described with reference to FIG. 7 may be performed at least in part by a centralized data processing platform (e.g., centralized server 520), for example, dedicated to a particular gaming location or one that serves multiple gaming locations.

At decision block 710, a determination is made regarding what type of event has triggered the receipt of information by the centralized data processing platform. Depending on the particular implementation, when a threshold amount of video frames have been captured by a given camera of the multiple cameras (e.g., cameras 501a-i) monitoring the field of play has been captured, the video frames may be transmitted to the centralized data processing platform. Other monitoring equipment may operate in a similar manner. Alternatively, captured data may be streamed from the monitoring equipment and queued for processing by the centralized data processing platform and/or by one or more intermediate data collectors logically interposed between the monitoring equipment and the centralized data processing platform. When it is determined that video frames have been received, the field of play monitoring process branches to block 720. When it is determined that a projectile launch has been detected, the field of play monitoring process continues with block 730. When no event has been detected, the field of play monitoring processing loops back to decision block 710.

As noted above, in one embodiment, the launch of a projectile may be detected based on information received from a given projectile launcher (e.g., projectile launcher 601) and/or based on sound analysis.

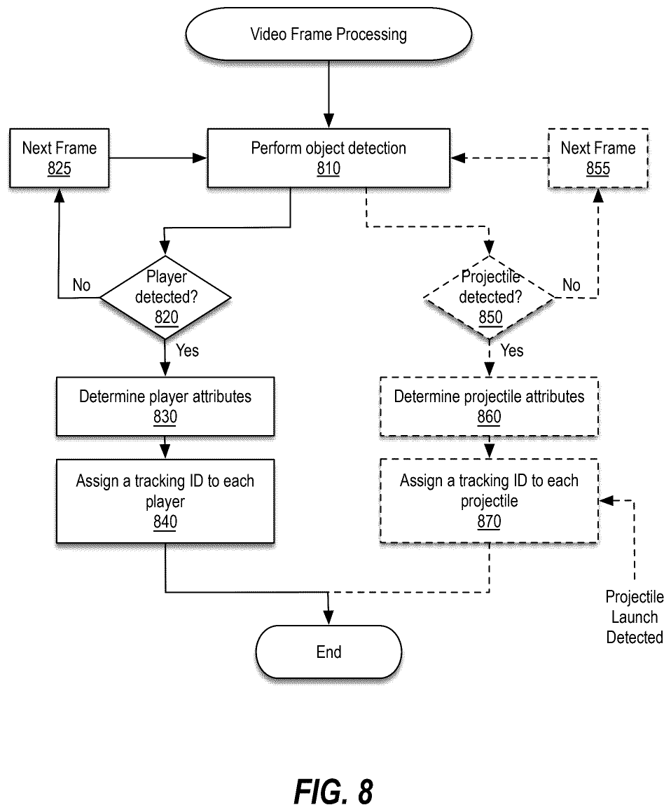

At block 720, a batch of video frames received is processed. In general, the processing of the video frames involves performing object detection. Depending on the particular implementation, the object detection may include detecting one or both of players and projectiles. A non-limiting example of video frame processing is described further below with reference to FIG. 8. As described further below, in some examples, a confirmation regarding the launch or firing of a projectile may be used by the video frame processing.

At optional block 730, a projectile path of a projectile fired from a particular projectile launcher is estimated. In one embodiment, the projectile path is estimated based on sensor data (e.g., data communicated to the centralized data processing platform read from an accelerometer or IMU associated with the particular projectile launcher. According to one embodiment, the centralized data processing platform receives telemetry data from the particular projectile launcher, including, for example, information regarding the orientation of the particular projectile launcher (e.g., data indicative of a release angle of the projectile and a height of the barrel) of the projectile launcher at the time of the firing of the projectile, an initial release velocity of the projectile, a time at which the projectile was fired from the particular projectile launcher, and a unique identifier associated with the particular projectile launcher). Some subset of the telemetry data may be supplied by or read from one or more sensors (e.g., an accelerometer or IMU) associated with the particular projectile launcher Those skilled in the art understand how to calculate a projectile's trajectory based on the aforementioned sensor data, for example, using the parabolic trajectory equation or the like. While projectile path estimation is described for a single filed projectile, those skilled in the art will appreciate projectile paths should be estimated for each detected projectile that has been fired. In order to achieve synchronization between multiple video streams from the multiple cameras, the Real-Time Streaming Protocol (RTSP) may be used in conjunction with one or more other techniques.

At block 740, triangulation is performed to determine the location and path for each player in the field of play that has been detected within the video frames and to determine the projectile path for each fired projectile (detected within the video frames and/or confirmed to have been launched via sound recognition or from telemetry data received from projectile launchers).

In one embodiment, for example, in which appropriate sensor data is available from projectile launchers, projected path information for fired projectiles is available from optional block 730. Depending on the particular implementation, the projected path information output from block 730 may be used alone or as a supplement to projectile path calculations performed based on visual data.

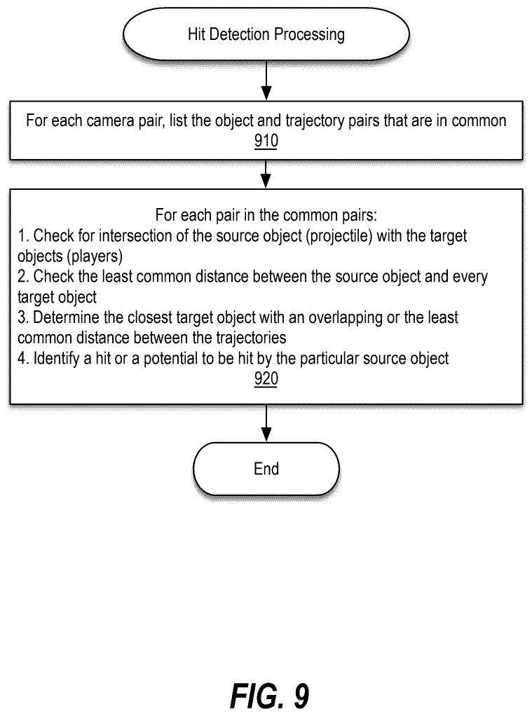

At block 750, hit detection is performed. As those skilled in the art will appreciate, hit detection generally involves predicting or determining whether a particular player has been impacted by a particular fired projectile within the field of play that is being tracked by the centralized data processing platform. A non-limiting example of hit detection processing is described further below with reference to FIG. 9.

At decision block 760, it is determined whether a hit was predicted by the hit detection processing. If so, processing continues with block 770; otherwise, processing loops back to decision block 710.

At block 770, an impact determination may be performed. Depending on the particular implementation, an additional AI model (e.g., a neural network) may make an inference confirming the predicted hit. In one embodiment, impact confirmation may include analyzing 3D intersections between projectile paths and player body volumes derived from pose estimation. This additional AI model may also make inferences regarding one or more of (i) the part of the body (e.g., head, torso, arm, leg, etc.) of the player at issue on which the projectile has or will impact and (ii) the type of impact (e.g., glancing, deflection, direct hit). For example, in one embodiment, a tool for annotating images and/or videos (e.g., Computer Vision Annotation Tool (CVAT) and/or Roboflow) may be used for labeling to produce custom datasets with player keypoints and projectile boxes with transfer learning from an image dataset (e.g., Common Objects in Context (COCO)), for example, that is used for object detection research. Depending on the particular implementation or depending on the particular type of game play, player scoring may take into consideration the part of the body of the impacted player and/or the type of impact. In some example, scoring is performed based on confirmed hits with or without weighting based on impact locations, for example, which may be determined via pose estimation models (e.g., OpenPose or MediaPipe).

While the present example is described in the context of a push model in which data and/or the occurrence of events are communicated to the centralized data processing platform, it is to be appreciated that a pull model may alternatively be employed in which the centralized data processing platform polls the various equipment (e.g., cameras, microphone array, triangulation sensors, WiFi positioning devices, etc.) that may be used to monitor the field of play. Alternatively, or additionally, intermediate data collectors may be employed and logically interposed between the equipment at issue and the centralized data processing platform to receive data from or pull data from the equipment. As those skilled in the art will appreciate such intermediate data collectors may operate as a buffer or queue to allow the centralized data processing platform to process batches of data (e.g., sets of a predetermined or configurable size of video frames from each camera) as it is capable of doing so, for example, based on compute, memory, and/or storage resource utilization/availability.

### Example Triangulation Process Overview

According to one embodiment, triangulation may involve calibrating the multiple cameras (e.g., cameras 501a-i) used for monitoring the field of play (e.g., field of play 510) to reconstruct 3D positions from detected 2D object correspondences across overlapping views, for example, using techniques such as epipolar geometry and optimization to compute accurate locations and paths. If the cameras are not synchronized, timestamp alignment may be used. For edge cases (e.g., in which fewer cameras are used), monocular depth estimation may be used via AI.

In one example, the system (e.g., the central server 520) first calibrates the multiple cameras, for example, using known fiducial markers (e.g., ArUco codes/markers) used in computer vision to determine intrinsic parameters (e.g., focal length, distortion, etc.) and extrinsic parameters (e.g., position, orientation relative to each other, etc.) of the multiple cameras. This calibration creates a shared 3D coordinate system for the field of play. Objects (players or projectiles) may be detected in synchronized video frames from at least two (ideally, three or more) overlapping camera views using one or more of deep learning models (e.g., those referenced herein or the like).

For each video frame, an AI pipeline (e.g., AI pipeline 400) identifies keypoints or centroids of objects. Correspondence matching links the same object across views (e.g., via epipolar constraints, where a point in one image lies on a line in another, or appearance embeddings for re-identification during occlusions).

Using the matched 2D points, the system may then solve for the 3D position via linear triangulation (e.g., direct linear transformation) or nonlinear optimization (e.g., bundle adjustment to minimize reprojection error). For paths/trajectories, positions over consecutive frames may be fitted to a model (e.g., parabolic under gravity, adjusted for drag via physics equations or Long Short-Term Memory (LSTM) neural networks. As those skilled in the art will appreciate, use of at least three cameras reduces ambiguity and improves accuracy (e.g., handling depth uncertainty), but two can suffice with additional constraints like known arena geometry.

In some examples, in order to handle fast-moving projectiles (up to 100+ FPS cameras), Kalman filters or particle filters may be used to predict positions during brief occlusions. These filters may be integrated with telemetry data (e.g., IMU data from projectile launchers) for initial velocity/angle, thereby fusing visual and sensor data.

### Example Video Frame Processing

FIG. 8 is a flow diagram illustrating video frame processing in accordance with an embodiment of the present disclosure. The video frame processing described with reference to FIG. 8 may be performed at least in part by a centralized data processing platform (e.g., centralized server 520), for example, dedicated to a particular gaming location or one that serves multiple gaming locations. The video frame processing described with reference to FIG. 8 represents a non-limiting example of video frame processing that may be performed by block 720 of FIG. 7.

In the context of the present example, blocks on the right-hand side are shown in dashed lines to convey the fact that these blocks are optional. Depending on the particular implementation, fired projectiles may be detected and tracked based on visual data (e.g., video frames received from the multiple cameras (e.g., cameras 501a-i) monitoring the field of play) or based on sound or projectile launcher sensor data (e.g., as described above with reference to block 730). In the case of the former, the video frames may be separately evaluated by separately trained object attribute neural networks (e.g., one for players and one for projectiles). Alternatively, the same object detection neural network may be trained to detect both players and projectiles within video frames. In some examples, sound classification may be used to detect projectile firing and provide a projectile launch detection signal.

At block 810 object detection is performed. In one embodiment, respective batches of video frames received from the multiple cameras (e.g., cameras 501a-i) monitoring the field of play are processed (e.g., in parallel or serially), for example, one video frame at a time, by feeding them into an object detection algorithm. According to one embodiment, the object detection algorithm is implemented by an AI-based object detection model (e.g., object detection stage 420), for example, that makes use of one or more CNNs (e.g., YOLOv8, EfficientDet, Detectron2, SD, Faster-R-CNN, or the like).

At decision block 820, as part of the object detection, it may be determined whether a given detected object is a player (e.g., one of players 510a-b). If a player is detected, processing continues with block 830; otherwise, processing branches to block 825. In one embodiment, one or more of the multiple cameras may employ thermal or IR imaging to aid in player identification in dim lighting or when visual markers are otherwise obscured.

At block 825, the next video frame of a given batch of video frames is identified for which object detection is to be performed and processing continues with block 810 until all video frames have been processed.

At block 830, player attributes are determined for each player that has been identified in a region of interest within a video frame. As noted above, various visual and/or non-visual characteristics or markers may be used. According to one embodiment, a player attributes neural network (e.g., CNN processing block 430) may be used to extract appropriate differentiating attributes that distinguish a given player from other players.

At block 840, a tracking ID is assigned to each player. In one embodiment, as a result of adding the player attributes neural network on top of Method 2 to process the differentiating attributes of the players and/or player uniforms, the internal assignment of tracking IDs to each player avoids the issue of potential use of duplicate tracking IDs for the same player. As such, at least one advantage of the proposed approach is the use of unique and persistent player identity (e.g., in the form of internally used player tracking IDs) being maintained for all tracked players including scenarios in which one or both of (i) a particular player is temporarily occluded or goes out of sight and reappears during a time at which the field of play is experiencing changing environment conditions and (ii) the particular tracked player transitions through multiple camera fields of view during a time at which the field of play is experiencing changing environment conditions. According to one embodiment, the assignment of unique tracking IDs to each player is based on the use of one or more tracking algorithms (e.g., Kalman filter, Hungarian algorithm, Deep SORT (with ResNet-50 embeddings), ByteTrack, TrackFormer and/or an appearance detector). In some examples, Vision Transformers (ViT) may be used for motion anticipation to predict future player movements or player actions based on observing ongoing events.

At decision block 850, as part of the object detection, it may be determined whether a given detected object is a fired projectile. If a projectile is detected, processing continues with block 860; otherwise, processing branches to block 855. As noted above, in one embodiment, one or more of the multiple cameras may employ thermal or IR imaging to aid in player identification in dim lighting or when visual markers are otherwise obscured.

At block 855, the next video frame of a given batch of video frames is identified for which object detection is to be performed and processing continues with block 810 until all video frames have been processed.

At block 860, projectile attributes are determined for each projectile that has been identified in a region of interest within a video frame. As noted above, various visual and/or non-visual characteristics or markers may be used. According to one embodiment, a projectile attributes neural network (e.g., CNN processing block 430) may be used to extract appropriate differentiating attributes that distinguish one type of projectile (e.g., having one or more distinguishing features, such as color surface pattern, or other markings) associated with one projectile launcher being employed by one player during game play from another type of projectile (having one or more different distinguishing features) and associated with another projectile launcher being employed by another player during game play.

At block 870, a tracking ID is assigned to each detected fired projectile. In one embodiment, as a result of adding the projectile attributes neural network on top of Method 2 to process the differentiating attributes of the projectiles, the internal assignment of tracking IDs to each projectile avoids the issue of potential use of duplicate tracking IDs for the same projectile. As such, at least one advantage of the proposed approach is the use of unique and persistent projectile identity (e.g., in the form of internally used projectile tracking IDs) being maintained for all tracked projectiles including scenarios in which one or both of (i) a particular projectile is temporarily occluded or goes out of sight and reappears during a time at which the field of play is experiencing changing environment conditions and (ii) the particular tracked projectile transitions through multiple camera fields of view during a time at which the field of play is experiencing changing environment conditions. According to one embodiment, the assignment of unique tracking IDs to each projectile is based on the use of one or more tracking algorithms (e.g., Kalman filter, Hungarian algorithm, Deep SORT (with ResNet-50 embeddings), ByteTrack, TrackFormer and/or an appearance detector). In one embodiment, a projectile launch detected signal (based on sound recognition and/or based on projectile launcher sensor data) may be supplied to block 870 to provide sensor-redundant firing detection. Such sensor-redundant firing detection may increase the confidence in fired projectile detection by the object detection algorithm utilized and/or reduce false positives.

### Example Hit Detection

FIG. 9 is a flow diagram illustrating operations for performing hit detection in accordance with various embodiments of the present disclosure. The hit detection processing described with reference to FIG. 9 may be performed at least in part by a centralized data processing platform (e.g., centralized server 520), for example, dedicated to a particular gaming location or one that serves multiple gaming locations. The hit detection processing described with reference to FIG. 9 represents a non-limiting example of hit detection that may be performed by block 750 of FIG. 7. In the context of the present example, it is assumed fired projectiles have been detected and assigned internal tracking IDs for a given batch of video frames received from each of the multiple cameras (e.g., cameras 501a-i) monitoring the field of play. It is also assumed trajectories have been estimated (e.g., based on visual data potentially supplemented with projectile launcher sensor data) for each fired projectile detected within the given batches of video frames.

In one embodiment, the hit detection processing builds on predicted trajectories (e.g., from FIG. 7), using a multi-step geometric and probabilistic algorithm to confirm impacts. For example, hit detection may integrate AI models (e.g., predictor and confirmer neural networks, such as those described above with reference to FIG. 6) for performance of real-time inference in dynamic arenas, handling occlusions and fast motion (e.g., projectiles at 10-50 m/s). In one example, a goal of hit detection is to determine if a projectile's path intersects a player's 3D body volume, thereby allowing the hit to be attributed to the shot originator for scoring without requiring the players to wear suits or uniforms incorporating physical sensors.

According to one embodiment, inputs to hit detection include 3D trajectories from triangulation (e.g., projectile paths as time-parameterized curves: r(t)=r0+v0t+21gt2, adjusted for air resistance via drag models like quadratic force), player positions (e.g., contained within a real-time location map), and player poses (e.g., from OpenPose or MediaPipe, yielding keypoints for limbs/torso, extruded to 3D volumes like capsules or meshes). Meanwhile, Kalman/particle filters may propagate uncertainties.

Depending on the particular embodiment, hit detection may involve listing common trajectory pairs across camera views, then checking intersections between projectile paths and player body volumes derived from pose estimation, calculating minimum distances for non-intersections, and identifying hits based on proximity thresholds, with or without AI confirmation for validation.

At block 910, for each camera pair of the multiple cameras, a list is created containing the projectile tracking ID and trajectory pairs that are in common. For example, assuming there are N cameras, N (N−1)/2 lists may be generated. In one embodiment, three or more views from calibrated cameras (using homography or extrinsic matrices) may be used to compile the lists of shared projectile-player trajectory pairs. The use of three or more views filters noise via multi-view consistency (e.g., reproject 3D estimates to 2D images) and check alignment (reprojection error<threshold, for example, 5 pixels). Graph matching or the Hungarian algorithm may be used to associate pairs, incorporating appearance embeddings (e.g., CNN features from DeepSORT) for re-identification during temporary or brief occlusions.

At block 920, a hit or a potential for a player to be hit is determined by processing each pair of the common pairs in each list. In one embodiment, the following processing is performed for each pair of the common pairs:
1. Check for intersection of the source object (e.g., the fired projectile) with the target objects (e.g., the players), for example, based on the real-time arena location map indicative of player locations. According to one embodiment, checking for intersection includes testing for spatial-temporal overlap between projectile trajectory and player body volume. For example, players may be represented as a union of primitives (e.g., cylinders for arms, sphere for head) derived from pose keypoints. The intersections may be computed analytically (e.g., ray-cylinder tests) or numerically (e.g., sample t along trajectory, to check if a point is inside volume via signed distance functions). In order to account for player motion, video frames may be synchronized via timestamps and/or player paths may be predicted with linear velocity or AI (e.g., LSTM on pose sequences).
2. Check the least common distance between the source object and every target object. In one example, for non-intersecting cases (e.g., near-misses), the minimum distance between curves may be computed, for example by minimizing d(tp,tq)=∥rproj(tp)−rplayer(tq)∥ over time windows (e.g., ±0.1 s), using optimization like gradient descent or closed-form for linear approximations with a threshold based on projectile size (e.g., foam ball radius˜2-5 cm) plus a margin for error.
3. Determine the closest target object with an overlapping or the least common distance between the trajectories. According to one embodiment, potential targets may be ranked by a score (e.g., score=intersection_volume+1/(dist+ε), where & prevents division by zero). Then, the minimum-distance or maximum-overlap target may be selected by incorporating probabilistic elements (e.g., Monte Carlo sampling from trajectory uncertainties).
4. Identify a hit on a given player or a potential for the given player to be hit by a particular source object based on #1 and/or #3. In one embodiment, a hit may be flagged if the score is greater than or equal to a predefined or configurable threshold (e.g., tunable via training data). In one embodiment, a confirmer neural network (e.g., confirmer neural network 640 or other CNN applicated to post-impact frame snippets) may be used to validate the flagged hit via visual cues (projectile deflection, player reaction) or auxiliary data (e.g., audio signatures from microphones). Additionally, in some examples, the confirmer neural network may distinguish impact types (e.g., direct vs. glancing via intersection depth) and body parts (e.g., headshot bonuses via keypoint labels). For purposes of game scoring, a hit or confirmed hit may be attributed to the shot originator via projectile tracking ID (e.g., mapped to the projectile launcher of the shot originator).

While in the context of various flow diagrams and block diagrams presented herein a number of enumerated blocks are included, it is to be understood that other examples may include additional blocks before, after, and/or in between the enumerated blocks. Similarly, in some examples, one or more of the enumerated blocks may be omitted and/or performed in a different order.

### Example Computer System

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

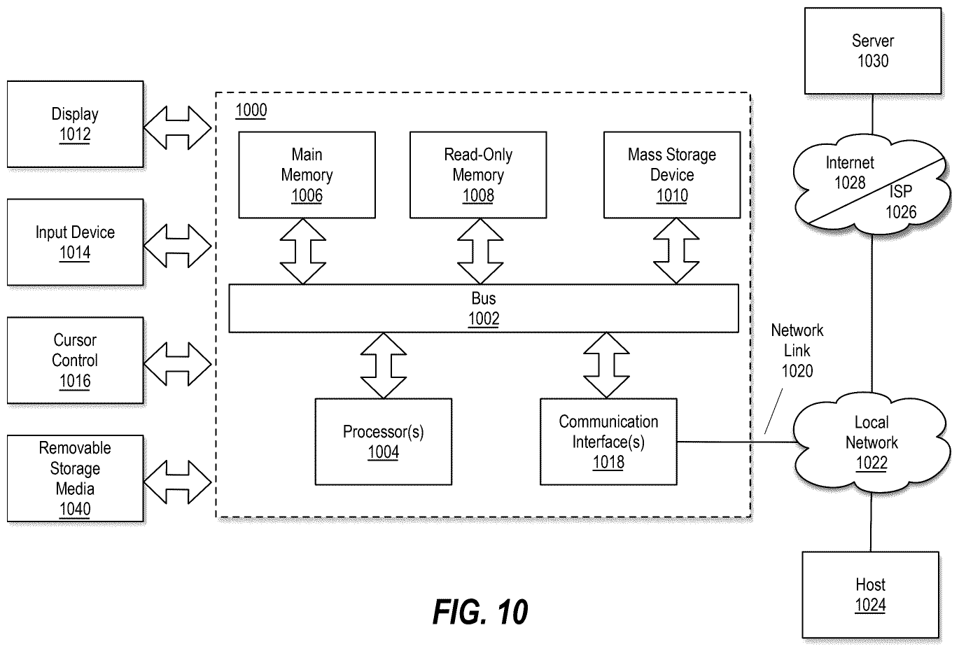

FIG. 10 is a block diagram that illustrates a computer system 1000 in which or with which an embodiment of the present disclosure may be implemented. Computer system 1000 may be representative of all or a portion of the computing resources of a physical host of one or more physical hosts on which a centralized data processing platform (e.g., centralized server 520) is deployed. Notably, components of computer system 1000 described herein are meant only to exemplify various possibilities. In no way should example computer system 1000 limit the scope of the present disclosure. In the context of the present example, computer system 1000 includes a bus 1002 or other communication mechanism for communicating information, and one or more processing resources (e.g., hardware processor(s) 1004) coupled with bus 1002 for processing information. Hardware processor(s) 1004 may be, for example, one or more general purpose microprocessors.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor(s) 1004. Such instructions, when stored in non-transitory storage media accessible to processor(s) 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor(s) 1004. A storage device 1010, e.g., a magnetic disk, optical disk or flash disk (made of flash memory chips), is provided and coupled to bus 1002 for storing information and instructions.

Computer system 1000 may be coupled via bus 1002 to a display 1012, e.g., a cathode ray tube (CRT), Liquid Crystal Display (LCD), Organic Light-Emitting Diode Display (OLED), Digital Light Processing Display (DLP) or the like, for displaying information to a computer user. An input device 1014, including alphanumeric and other keys, is coupled to bus 1002 for communicating information and command selections to processor(s) 1004. Another type of user input device is cursor control 1016, such as a mouse, a trackball, a trackpad, or cursor direction keys for communicating direction information and command selections to processor(s) 1004 and for controlling cursor movement on display 1012. This input device typically has two degrees of freedom in two axes, a first axis (e.g., x) and a second axis (e.g., y), that allows the device to specify positions in a plane.

Removable storage media 1040 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1000 may implement the techniques described herein using customized hard-wired logic, one or more ASICs or FPGAs, firmware or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1010. Volatile media includes dynamic memory, such as main memory 1006. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor(s) 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor(s) 1004 retrieve and execute the instructions. The instructions received by main memory 1006 may optionally be stored on storage device 1010 either before or after execution by processor(s) 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor(s) 1004 as it is received, or stored in storage device 1010, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
capturing video data from a plurality of cameras monitoring a field of play;
tracking (i) a plurality of players and (ii) projectiles fired from respective projectile launchers associated with a subset of the plurality of players representing shot originators by applying one or more deep learning algorithms to the video data;
predicting projectile trajectories and potential player impacts by one or more projectiles of the projectiles;
identifying a player of the plurality of players as an impacted player by confirming a hit on the player by a projectile of the projectiles fired from a projectile launcher of the respective projectile launchers associated with a given shot originator of the shot originators without requiring use of a physical impact sensor on an outfit worn by the player; and
attributing the hit to the given shot originator for scoring purposes.

2. The method of claim 1, further comprising after firing of a projectile by a particular projectile launcher of the respective projectile launchers, receiving telemetry data from the particular projectile launcher.

3. The method of claim 2, wherein the telemetry data includes information indicative of one or more of a location of the particular projectile launcher, a release angle of the projectile, an initial release velocity of the projectile, a time at which the projectile was fired from the particular projectile launcher, and a unique identifier associated with the particular projectile launcher.

4. The method of claim 1, further comprising training the one or more deep learning algorithms using synthetic data generated from simulation environments and fine-tuning with real footage of the field of play.

5. The method of claim 1, wherein said confirming a hit includes analyzing a three-dimensional intersection between a path of the projectile and the player based on a player body volume derived from pose estimation.

6. The method of claim 1, further comprising one or both of:
re-identifying a first projectile of the projectiles across multiple camera fields of view during which environment conditions change in the field of play based on appearance embeddings associated with the first projectile; and
re-identifying a second projectile of the projectiles across an occlusion during which environment conditions change in the field of play based on appearance embeddings associated with the second projectile.

7. A non-transitory machine readable medium storing instructions, which when executed by one or more processing resources of one or more computer systems, cause the one or more computer systems to:
capture video data from a plurality of cameras monitoring a field of play;
track (i) a plurality of players and (ii) projectiles fired from respective projectile launchers associated with a subset of the plurality of players representing shot originators by applying one or more deep learning algorithms to the video data;
predict projectile trajectories and potential player impacts by one or more projectiles of the projectiles;
identify a player of the plurality of players as an impacted player by confirming a hit on the player by a projectile of the projectiles fired from a projectile launcher of the respective projectile launchers associated with a given shot originator of the shot originators without requiring use of a physical impact sensor on an outfit worn by the player; and
attribute the hit to the given shot originator for scoring purposes.

8. The non-transitory machine readable medium of claim 7, wherein the instructions further cause the one or more computer systems to after firing of a projectile by a particular projectile launcher of the respective projectile launchers, receive telemetry data from the particular projectile launcher.

9. The non-transitory machine readable medium of claim 8, wherein the telemetry data includes information indicative of one or more of a location of the particular projectile launcher, a release angle of the projectile, an initial release velocity of the projectile, a time at which the projectile was fired from the particular projectile launcher, and a unique identifier associated with the particular projectile launcher.

10. The non-transitory machine readable medium of claim 7, wherein the instructions further cause the one or more computer systems to train the one or more deep learning algorithms using synthetic data generated from simulation environments and fine-tuning with real footage of the field of play.

11. The non-transitory machine readable medium of claim 7, wherein predicting trajectories and potential player impacts includes use of a predictor neural network that processes launch parameters and a real-time location map indicative of locations of the plurality of players within the field of play.

12. The non-transitory machine readable medium of claim 7, wherein said confirming a hit includes analyzing a three-dimensional intersection between a path of the projectile and the player based on a player body volume derived from pose estimation.

13. The non-transitory machine readable medium of claim 7, wherein the instructions further cause the one or more computer systems to re-identify one or more projectiles of the projectiles across multiple camera fields of view during which environment conditions change in the field of play based on appearance embeddings associated with the one or more projectiles.

14. The non-transitory machine readable medium of claim 7, wherein the instructions further cause the one or more computer systems to re-identify one or more projectiles of the projectiles across occlusions during which environment conditions change in the field of play based on appearance embeddings associated with the one or more projectiles.

15. The non-transitory machine readable medium of claim 7, wherein player localization combines wireless signals with visual data for enhanced accuracy.

16. A system comprising:
one or more processing resources; and
instructions that when executed by the one or more processing resources cause the system to:
capture video data from a plurality of cameras monitoring a field of play;
track (i) a plurality of players and (ii) projectiles fired from respective projectile launchers associated with a subset of the plurality of players representing shot originators by applying one or more deep learning algorithms to the video data;
predict projectile trajectories and potential player impacts by one or more projectiles of the projectiles;
identify a player of the plurality of players as an impacted player by confirming a hit on the player by a projectile of the projectiles fired from a projectile launcher of the respective projectile launchers associated with a given shot originator of the shot originators without requiring use of a physical impact sensor on an outfit worn by the player; and
attribute the hit to the given shot originator for scoring purposes.

17. The system of claim 16, wherein the instructions further cause the system to after firing of a projectile by a particular projectile launcher of the respective projectile launchers, receive telemetry data from the particular projectile launcher.

18. The system of claim 16, wherein the instructions further cause the system to train the one or more deep learning algorithms using synthetic data generated from one or more simulation environments and perform fine-tuning with real footage of the field of play.

19. The system of claim 16, wherein said confirming a hit includes analyzing a three-dimensional intersection between a path of the projectile and the player based on a player body volume derived from pose estimation.

20. The system of claim 16, wherein the instructions further cause the system to one or both of:
re-identify a first projectile of the projectiles across multiple camera fields of view during which environment conditions change in the field of play based on appearance embeddings associated with the first projectile; and
re-identify a second projectile of the projectiles across an occlusion during which environment conditions change in the field of play based on appearance embeddings associated with the second projectile.
